(19) United States
(12) Patent Application Publication
(10) Pub. No.: US 2007/0200665 A1
(43) Pub. Date: Aug. 30, 2007

(54) Access control system and method for operating said system

(75) Inventor: Paul Studerus, Oberweningen (CH)

Correspondence Address: SUGHRUE MION, PLLC, 2100 PENNSYLVANIA AVENUE, N.W., SUITE 800, WASHINGTON, DC, 20037, US

(73) Assignee: KABA AG

(21) Appl. No.: 10/585,317

(22) PCT Filed: Dec. 16, 2004
(86) PCT No.: PCT/CH04/00739

§ 371 Date: Jul. 6, 2006

(30) Foreign Application Priority Data
Jan. 6, 2004 (CH) 12/04

(51) Int. Cl. G05B 19/00

(52) U.S. Cl. 340/5.61; 340/5.7; 340/5.5; 455/41.2

(57) ABSTRACT

The invention relates to an access control system and to a method for operating said system. The system uses a standard access control system (24, 8), which controls a plurality of access points (1) by means of respective individual physical closing mechanisms (8). According to the invention, at least one reader (2) and a controller (3), which is connected to the latter in order to control the closing mechanism (8), is provided at each access point (1) and the system is equipped with at least one access control server (4), which carries out the centralised management of access data and is connected to the respective controllers (3), in addition to at least one mobile telephone server (5), which is connected to the access control server (4), said mobile telephone server being at least indirectly capable of transmitting data to mobile radio telephone subscribers (7) via a mobile radio telephone network and of receiving data from said subscribers. The mobile radio telephone server (5) can also be an integral component of the access control server (4). The aim of the invention is to provide an access control system that uses mobile telephones, which can be easily retrofitted and is especially user-friendly and at the same time reliable. To achieve this, at least one access point (1) is equipped with a short-range transmitter (9), which transmits identification information that is specific to the access point in such a way that it is only received by a mobile telephone (7) located in the direct vicinity of the access point (1) and is used at least indirectly by said telephone to control the access verification process. The use of Bluetooth or WLAN transmitters (9) is particularly advantageous in this context as modern mobile telephones (7) are already equipped with interfaces of this type and Bluetooth transmitters (9) are cost-effective and readily available.

### TECHNICAL FIELD

The present invention relates to an access control system and to a method for its operation. The access control system is based on a standard access control system via which a large number of access points can each be controlled via individual physical locking mechanisms, with at least one reader as well as a controller, which is connected to it, for controlling the locking mechanism being provided at each access point. Furthermore, at least one access control server is provided which carries out central management of-the access data and is connected to the respective controllers, as well as at least one mobile telephony server connected to the access control server, which is at least indirectly able to send data via a mobile telephone network to mobile telephone subscribers, and to receive data from them.

### PRIOR ART

Access control systems are essentially electronically controlled centralized systems which monitor, control and manage the access through a large number of access points (gateways). Modern access control systems are in this case frequently based on non-contacting technology, that is to say a physical key is no longer used at the access point, but electronically legible media which are activated by corresponding readers provided at the access points, and are read by them. These electronically legible media are typically known by the expression RFID (Radio Frequency Identification), and advanced technologies, such as that with the trade name LEGIC® from the applicant, have been successfully and reliably used for a relatively long time.

The procedure for using an RFID medium for the purposes of an access control system such as this is normally as follows:

A person stands in front of the reader at the gateway (access point) for which he wishes to gain access. He presents his medium (RFID tag), and the system checks whether the medium is known, a profile exists, and this allows access at this time. If OK, this is signaled to the reader and the door is released once by the controller.

This technology is particularly suitable for long-term employees who can be equipped with an electronic medium such as this which then allows both access control and possibly also time recording or further applications.

Nowadays, however, there is an increasing requirement to allocate short-term access authorizations to maintenance personnel or the like, possibly in emergency situations even on a very short time scale, which makes the issuing of appropriate physical media (for example RFID tags) virtually impossible. Furthermore, every issue of corresponding media involves the risk of loss, and thus of security breaches.

Recently, there has correspondingly been a trend and a need to possibly use mobile telephones (cellular telephones) as a replacement or at least a supplement for these electronic media. In this case, the procedure is typically as follows:

A person enters the gateway number (that is to say an identification of the specific access point) for which he wishes to gain access using a mobile telephone dialogue. He confirms the input, possibly by means of his personal PIN code. This data is transmitted via the mobile telephone network to the access system server (access control server), which checks whether the mobile telephone number is known, the PIN code is correct, a profile exists (is this mobile telephone number with this PIN code authorized for this specific access point at this specific time), and allows this person access at this time. If, OK, this is signaled to the reader and the door is released once by the controller (in this case initiated by the server).

### DESCRIPTION OF THE INVENTION

The invention is accordingly based on the object of proposing an access control system which is better in this respect, as well as a method for its operation. The access control system is based on a standard access control system, via which a large number of access points can each be controlled via individual physical locking mechanisms, with at least one reader as well as a controller, which is connected to it, for controlling the locking mechanism being provided for each access point. Furthermore, at least one access control server is provided, which carries out central management of the access data and is connected to the respective controllers, as well as at least one mobile telephony server connected to the access control server, which is at least indirectly able to send data via a mobile telephone network to mobile telephone subscribers, and to receive data from them.

This object is achieved in that a short-range transmitter is provided at one specified location and transmits access-point-specific identification information in such a manner that this is received only by a mobile telephone which is located in the reception area of the transmitter, and is used at least indirectly by this to control the access control at a specific associated access point.

The essence of the invention is thus on the one hand to allow the access point to be opened only by mobile telephones which are also actually in the immediate vicinity of this transmitter, and are thus in the immediate vicinity of a specific location. This is because, if this were not to be the case, it would be possible for a corresponding procedure to be initiated by a mobile telephone without having to be physically present at a specific location. This is a safety breach. The present situation now prevents this by allowing an appropriate opening request to be transmitted only by the mobile telephone when it receives the identification information of the transmitter via an appropriate interface.

The specific location is in this case on the one hand the immediate vicinity of the associated access point, with the transmitter in this case preferably being positioned such that the mobile telephone can receive this transmitter only when it is immediately in front of the access point.

On the other hand, however, it is also possible to deliberately arrange the transmitter in front of the access point, for example in the case of a vehicle entrance, in such a manner that a goods vehicle driver can open an access using his mobile telephone, without having to leave the vehicle.

One fundamentally different alternative comprises a specific area being released for authorization of a specific access. It is thus possible, for example, for a transmitter to be arranged in a monitoring area or in another working area so that someone who is located in this monitoring area can open one or more access points via a mobile telephone. In this case in particular, it is also possible to associate one transmitter with a plurality of access points. In this case, it is, however, subsequently also necessary to state via the access control server in the authorization process which of the access points associated with the same identification should be opened.

However, on the other hand, the reception of the identification information of the transmitter also includes an additional simplification and an increase in the security from a different point of view. Without a corresponding local identification, the user of the mobile telephone, if he is not just authorized for access at a specific access point, must enter an identification of that specific access point on his mobile telephone at a specific moment. This procedure is on the one hand tedious and on the other hand is susceptible to errors and can be manipulated. In principle, it would also be possible to use the cell information of the mobile telephone for such localization, although it has been found in practice that, on the one hand, the cell information is normally locally insufficiently accurate for individual access points (different gateways in the same cell), and that the cell which is currently being used by a specific user may also be different depending on the mobile telephone operator and, furthermore, will always have to be readjusted for different cells in the access control system.

A further major advantage of the proposed method is that the mobile telephone is actually not used as a so-called “trusted device”, but that only the telephone number associated with the mobile telephone, as it is received by the access control server from the associated mobile telephony server, is used for authentication, possibly in conjunction with a PIN code. In other words, no specific data is stored on the mobile telephone, and, if required, it is possible, for example by using the same SIM card, to also use another mobile telephone for the same access authorizations.

In this context, it must also be mentioned that the expression mobile telephone fundamentally should be understood as meaning appliances which on the one hand are able to interchange data with the access control system via a mobile telephone network, for example the GSM network, and which on the other hand are able to receive signals transmitted from the transmitter, that is to say which have an appropriate interface. Accordingly, this need not necessarily be a mobile telephone in the traditional sense, and it may also be a PDA (Personal Digital Assistant) or some other computer, provided that it has the cited capabilities for communication with the transmitter and the access control system.

According to a first preferred embodiment of the present invention, the transmitter is a Bluetooth appliance, particularly preferably with a range of less than 10 meters. Modern mobile telephones normally have Bluetooth interfaces, and it is accordingly been found to be particularly simple for the respective transmitter at the access point to be in the form of a Bluetooth appliance, since no additional user-end hardware is required. The Bluetooth standard automatically leads to continuous checking and continuous reception of 48 bit addresses which are specifically associated with the individual appliances. Thus, when a mobile telephone such as this enters the area of another Bluetooth appliance, they automatically interchange the ID (48-bit address) between them. This fact is made use of according to the invention for “localization”. A Bluetooth appliance is simply arranged at the relevant gateway (access point). The ID of this appliance is assigned to the reader or to the access point in the system. The identification information is thus preferably a hardware-specific, unique address of the transmitter, in particularly preferably an appliance-specific 48-bit address of a Bluetooth appliance.

One alternative or additional option is to use a WLAN transmitter (Wireless Local Area Network, or WLAN for short, also referred to as wi-fi, which represents “wireless local area network”, which generally means the IEEE 802.11 Standard. This Standard specifies a plurality of wireless transmission techniques and methods for medium access. Appliances which operate on the basis of the 802.11b variant transmit data by means of radio waves in the unlicensed ISM band at 2.4 GHz with a gross transmission rate of up to 11 Mbit/s). This solution is particularly advantageous because WLAN appliances such as these may already be present in a building, and because of in particular, PDAs increasingly having corresponding interfaces.

If a person now wishes to gain access using a mobile telephone, he must be in the area of that Bluetooth/WLAN transmitter which is assigned to that gateway. This may be physically the same location or else a different location to that of the reader (for example goods vehicle entry or monitoring area). There is therefore no need to also enter the gateway number (this is automatically known via Bluetooth ID or WLAN identification, when the Bluetooth/WLAN appliance is installed at the access point, the corresponding correlation between the Bluetooth/WLAN ID and the access point need be indicated to the system only once). This ID is now sent to the access control server, possibly with a PIN or some other authentication. In contrast to other already known access control systems using Bluetooth technology, no effective link is in the present case produced, however, between the mobile telephone and the Bluetooth appliance at the access point, but, instead, only the ID of the Bluetooth appliance is read by the mobile telephone at the access point, in order to subsequently use this information for localization of the mobile telephone. Those transmission functions of the Bluetooth or WLAN interface which are actually possible are, in other words, not used. This is among other factors, since the sole use of the Bluetooth interface would necessitate complete integration of the Bluetooth appliance at the corresponding access point, in this case making retrofitting complex. Specifically, in the present case, one major aspect is that a standard access control system can be retrofitted in a particularly simple manner.

The transmitter may in the present case be in the form of an independent unit, including a unit equipped with an individual power supply, since, so to speak, it is used only for production of the localization information on the mobile telephone. The transmitter, as stated preferably a Bluetooth or a WLAN appliance, thus preferably has no direct connection to the standard access control system, and/or to the mobile telephony server. Furthermore, an ID can be transmitted on a very short time scale of less than a few seconds, while the process of setting up an effective Bluetooth connection typically takes in the region of 10 seconds. This is generally a time interval that is too long in practice. Only one very specific aspect of the Bluetooth technology is thus used, making use, so to speak, of the advantages in conjunction with access control, without having to accept the disadvantages such as the slowness of setting up a connection.

This is preferably an access control system which mainly manages access control using standard technology. The standard access control system thus mainly allows, for example, access control using means without mobile telephony, in particular based on RFID technology.

If required, for emergency situations, it is advantageous to design the transmitter such that the transmitter additionally has a connection to the controller, so that, in the event of a failure of the connection between the controller and the access control server, user-specific identification information can be transmitted from the mobile telephone to the transmitter, and can be transmitted from there to the controller in order to control the locking mechanism. While, in other words, the transmitter is used exclusively as a transmitter during normal operation, so that information is transmitted only from the transmitter to the mobile telephone, the reverse path can also additionally be enabled in emergency situations, that is to say it is possible to transmit information from the mobile telephone to the transmitter, which then acts as a receiver.

The present invention also relates to a method for access control, particularly preferably using an access control system as has been described above. In this case, a standard access control system is provided, via which a large number of access points can each be controlled via individual physical locking mechanisms, with at least one reader as well as a controller, which is connected to it, preferably being provided in order to control the locking mechanism for each access point. Furthermore, at least one access control server is provided, carries out central management of the access data, and is connected to the respective controllers. Furthermore, at least one mobile telephony server is provided, connected to the access control server, and is at least indirectly able to send data via a mobile telephone network to mobile telephone subscribers, or to receive data from them, in which case this mobile telephony server may also be an integral component of the access control server. Furthermore, a short-range transmitter is arranged at at least one access point or, more generally, at a specific location.

The procedure according to the invention is now that a mobile telephone is authorized for access at specific access points in a specific time period via the access control server, and/or via the mobile telephony server via the mobile telephone network. This procedure can be initiated by an appropriate person. The transmitter at the corresponding access point or more generally at the specific location transmits access-point-specific identification information continuously or at times, in such a manner that it can be received only by a mobile telephone which is located in the immediate vicinity of the access point (when the transmitter is arranged in its vicinity) or of the transmitter (control of the physical presence at the access point or close to the transmitter). A mobile telephone which is located in the immediate vicinity of the access point or of the transmitter now detects the identification of this access point via this identification information, the access point associated with the transmitter is then opened, with direct or indirect use of this identification information, via the mobile telephone, the mobile telephone network, the mobile telephony server, the access control server and the controller, in an automated form. The data is in this case preferably transmitted for the mobile telephone via the mobile telephone network either as a telephone transmission, as an e-mail or as an SMS (Short Message Service, CEPT Standard for short text messages, that is to say up to 160 alphanumeric characters, to mobile telephones in the GSM network, which are displayed on the mobile telephone display).

According to a first preferred embodiment, after detection of the identification information, the mobile telephone additionally demands the input of an authentication in particular such as a PIN code, password or biometric information, and this user-specific information is then transmitted together with the identification of the access point to be processed via the mobile telephone network to the mobile telephony server and to the access control server. The associated controller is then activated, or the locking mechanism is then released, with appropriate authorization.

As has already been mentioned further above, the transmitter is preferably a Bluetooth or WLAN appliance, which transmits its unique 48-bit address as identification information. This 48-bit address is used to identify the associated access point. The mobile telephone has a Bluetooth interface, in which case, the mobile telephone automatically starts an appropriate dialogue with the mobile telephone user on reception of specific 48-bit addresses of this type, which are transmitted in the course of the authorization process and correspond to the authorized access points, that is to say are identified by this. If required, user authentication is then requested (for example a PIN code). In any case, a request to open the specific access point is then transmitted via the mobile telephone network to the mobile telephony server and to the access control server. After checking the authorization, the access control server will then initiate the controller, provided that the authorization is satisfactory.

The security can be further improved if, according to a further preferred embodiment of the method according to the invention, the Bluetooth or WLAN appliance is arranged in the area of the access point in such a way that the identification information can be received by a mobile telephone only within a distance of less than 1 m, particularly preferably less than 0.5 m outside and in front of the access point.

Further preferred embodiments of the access control system and of the method for access control are described in the dependent claims.

Furthermore, the present invention relates to a time recording system which is likewise based on the same idea of using a transmitter, in particular a Bluetooth appliance, exclusively for monitoring the physical presence of a mobile telephone in order to open a data transfer. The time recording system in this case has a standard time recording system which comprises at least one time recording server which carries out central management of the time data. It also has at least one mobile telephony server in conjunction with the time recording server, which is at least indirectly able to transmit data via a mobile telephone network to mobile telephone subscribers, or to receive data from them, in which case this mobile telephony server may also be an integral component of the time recording server. The time recording system according to the invention is distinguished in that a short-range transmitter is provided for at least one authorized area and transmits area-specific identification information in such a way that it is received only by a mobile telephone which is located in the immediate vicinity of the authorized area, and is used by this mobile telephone at least indirectly for the manipulation of the time data. This makes it possible to ensure that, when using mobile telephones for time recording, appropriate requests and inputs are possible only in specific areas. By way of example, it is possible to authorize individual floors or only entry areas etc., as a precaution against misuse.

The present invention also relates to a method for time recording, particularly preferably using a time recording system as has been described above. The method in this case has a standard time recording system which comprises at least one time recording server carrying out central management of the time data; furthermore, at least one mobile telephony server is provided in conjunction with the time recording server, which is at least indirectly able to transmit data via a mobile telephone network to mobile telephone subscribers, or to receive data from them, in which case this mobile telephony server may also be an integral component of the time recording server; furthermore, a short-range transmitter is provided for at least one authorized area.

The method is now characterized in particular in that a mobile telephone is authorized to input time data in specific authorized areas, in at least one specific time period, via the time recording server and via the mobile telephony server via the mobile telephone network, in that the transmitter transmits area-specific identification information continuously or at times, in such a manner that it can received only by a mobile telephone which is located in the immediate vicinity of the authorized area, in that a mobile telephone which is located in the immediate vicinity of the area detects the identification of this area via this identification information, and in that time data is then transmitted to the time recording server, and/or can be checked by the latter, via the mobile telephone, the mobile telephone network and the mobile telephony server.

Further preferred embodiments of the time recording system and of the method for time recording are described in the dependent claims.

Furthermore, the present invention relates not least to a specific data processing program (software) which can run on a mobile telephone and which makes it possible to carry out a method for access control and for time recording, as has been described above. The data processing program is for this purpose able to transmit automatically the identification information received from the transmitter, if required in conjunction with further identification such as a PIN code or the like, to the access control. The present invention also relates to a mobile telephone or, in principle, any other appliance in which a data processing program such as this is loaded, or from which a data processing program such as this can be downloaded.

### BRIEF DESCRIPTION OF THE FIGURE

The invention will be explained in more detail in the following text with reference to exemplary embodiments and in conjunction with the drawing.

FIG. 1 shows a schematic illustration of an access control system.

### APPROACHES TO IMPLEMENTATION OF THE INVENTION

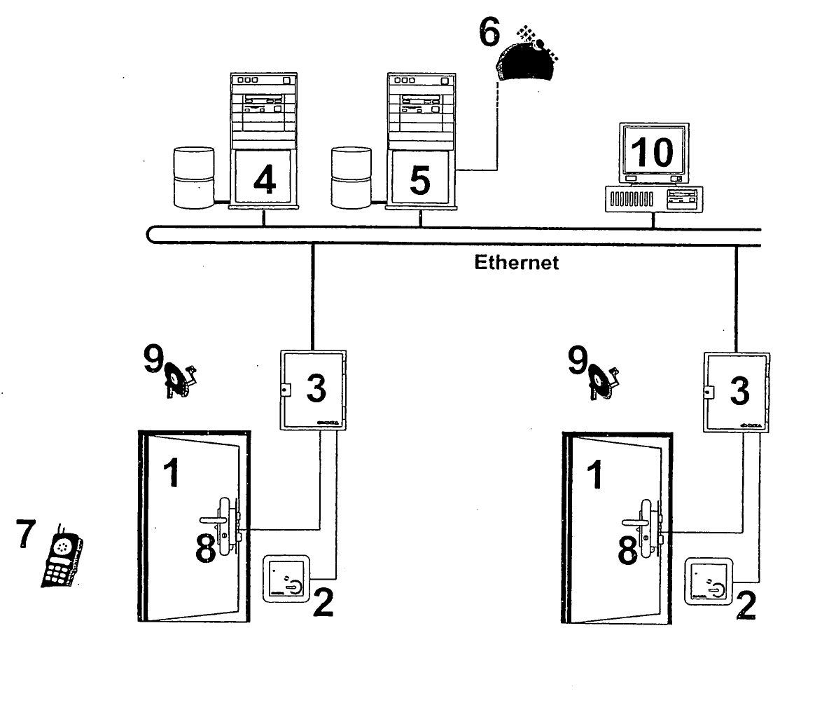

FIG. 1 shows a schematic illustration of an access control system. The invention will be explained with reference to this illustration, without this restricting the scope of protection as it is worded in the claims.

The access control system comprises an access control server 4 on which access authorizations are stored and managed. The access control server 4 can also at the same time carry out a time control process in addition to access control, that is to say the corresponding time data can be stored and managed on a person-specific basis. The access control server 4 is connected on the one hand to a large number of access points (that is to say gateways 1 and 1′). It manages the access, that is to say the possible opening and/or closing of these access points. For this purpose, a controller 3 is first of all arranged at the individual access points 1 and is used inter alia as an interface to the access control server 4, and on which specific information for the access control server is reflected, depending on the configuration of the system. On the one hand, the controllers 3 carry out the task of processing the data received by a reader 3 and of using this either directly or only after appropriate consultation of the access authorizations on the access control server 4. In this case, use means that the controller 3 physically activates appropriate locking mechanisms 8, that is to say by way of example withdraws bolts or the like, so that the access point, that is to say the gateway 1, can be opened by the user.

The access control system described so far relates to an access control system according to the prior art. Access control systems such as these-may in this case be used in combination with electronic, mechatronic and/or mechanical components and are, for example, available from the applicant under the trade name Kaba exos® in combination with RFID technologies under the name LEGIC®.

It will be assumed that an access control system such as this is already available using RFID technology, that is to say the reader 2 is designed to read corresponding RFID tags. A system such as this is now intended to be retrofitted in a simple manner for specific situations, so that people who normally do not have access authorizations in buildings managed in this way, that is to say who do not already have an appropriate RFID appliance, are provided with access authorization, in particular in the short term or medium term. First of all, for this purpose, one possibility is provided for allowing access authorizations via mobile telephones 7. For this purpose, the access control system must first of all be linked to the mobile telephone network. For this purpose, a GSM server 5 (Global System for Mobile Communication) is linked to the access control server 4. This GSM server 5 is connected at least indirectly to an antenna 6 which allows communication with mobile telephones 7, typically via relay stations etc.

Furthermore, a Bluetooth or alternatively or additionally a wireless LAN (WLAN) appliance 9 is arranged at each access point 1. This appliance 9 is in this case provided in the area of the access point 1 in such a manner that a corresponding receiver, for example a mobile telephone 7 with a Bluetooth or WLAN interface, receives this appliance 9 only when the mobile telephone 7 is arranged substantially immediately in front of the gateway 1.

In principle, Bluetooth is a protocol for wireless data transmission. The standard is used for data transmission by means of short-wave radio in the ISM network, which can be used globally without any licenses (2.45 GHz, as in IEEE 802.11b), with a maximum range of 10 m, or by amplification up to a maximum of 100 m (generally not envisaged in the present case). Transmission speed reaches 1 Mbit/s. The connection type is one-to-one. In addition to a data channel, speech channels are also available. This system is intended in particular for so-called PANs (Personal Area Network), that is to say for very local personal wireless networks, which are intended to be set up as automatically as possible, that is to say without any specific influence by the user. This therefore means the near area within a maximum of 10 meters around a person.

The Bluetooth method is intended to make cable-based data transmission superfluous. This makes it possible, for example, to install wireless local area networks, or to allow data transmission between mobile and stationary appliances. In this case, the data can also be interchanged automatically, as soon as the range is undershot. A further application field is networking in the private domain.

In order to be Bluetooth-compatible, the appliances must be equipped with a Bluetooth chip for transmission and reception control. The Bluetooth Standard was specified by the Bluetooth Special Interest Group, Bluetooth 1.0, in July 1999. The Standard is open. Every appliance has a unique 48-bit address, which continuously communicates with the outside world. When two Bluetooth-compatible appliances come into sufficiently close contact, then they automatically interchange the corresponding ID addresses in accordance with the protocol.

Wireless LAN (WLAN) is a further, open Standard (IEEE 802.11) for wireless data transmission and, in contrast to Bluetooth, will be increasingly used in the future especially for relatively large amounts of data and distances. Wireless data transmission and a respectively unique identification will also be used in this case, and the WLAN is thus likewise suitable for the proposed method. In particular, this is because appliances which are compatible with mobile telephony are increasingly being equipped with WLAN interfaces (for example PDAs which are mobile telephony compatible). If no mobile telephones with Bluetooth are available, or a greater range needs to be possible, or if, for example, such WLAN equipment is already provided in a building, this technology can be used alternatively or in parallel in the proposed method. Thus, in principle, Bluetooth or the WLAN Standard offers a very wide range of communication options. However, the Bluetooth/WLAN appliance 9 is used in the present case only in the form of a transmitter, that is to say the only characteristic that is made use of is that an appliance 9 such as this continuously transmits its unique address. As has already been mentioned, this is to ensure the physical presence of the mobile telephone in the area of the access point 1, and in order to transmit the identity of the access point.

It is extremely simple to retrofit the conventional access control system with Bluetooth or WLAN appliances 9 such as these. Essentially, this is done by fitting an appliance 9 such as this to each entrance which may need to be released, in such a manner that reception by means of a mobile telephone 7 is essentially possible only directly in front of the entrance 1. Typically, reception of the specific ID of the appliance 9 by a mobile telephone 7 should be possible only when the mobile telephone 7 is within 1 meter of the entrance 1.

One particularly advantageous feature of the present invention is that the appliance 9 need in no way be physically linked to the access control system, that is to say there is no need for example, to connect the appliance 9 to the controller 3, and to coordinate it with the controller 3. The appliance 9 is just arranged in the area of the gateway 1 and can, for example, also be supplied via a separate power supply. The only step which is then necessary is association of the unique address of a specific appliance 9 with a specific gateway 1. This can be done just by reading this ID once, and then associating this ID with that specific entrance 1 in the access control server 4. This creates a virtual access point, so to speak.

One exemplary method will now be described in the following text, in which a temporary access control is allocated:

In the course of the maintenance work in a building which is managed by an access control, one person is exceptionally intended to be allocated authorization for one afternoon to in each case allow use of the main entrance to a building complex, for access.

A manager of the access control system then enters the mobile telephone number of the person, for example into a control station 10, directly or indirectly on the access control server 4, instead of or in addition to the RFID medium, and allocates specific access authorizations to this mobile telephone number, in this specific case allocating the authorization to use the main entrance to the building complex in each case during the predetermined afternoon.

The unique addresses which are associated with the main entrances to the building complex for the Bluetooth/WLAN appliances 9 which are arranged at these main entrances are then either transmitted directly to the mobile telephone of that person, normally together with software (for example Java) which can run on the mobile telephone, and are stored in it; alternatively, and this solution is preferable because no data is stored in the mobile telephone and the mobile telephone can thus if required be changed, provided that the same mobile telephone number is associated with it, this software is just provided on the access control system without any associated addresses of the permitted appliances 9, in such a manner that, when contact is first made with the mobile telephone of that person (for example when this person is in front of the door and dials a corresponding mobile telephone number for the first time) the associated software is automatically transferred to the mobile telephone by means of the access control server or its GSM server 5.

When the person now comes into the vicinity of a specific main entrance to the building complex at the correct time, that is to say on the afternoon that has been cleared, then the Bluetooth-compatible mobile telephone of that person automatically receives the unique address of the appliance at this specific main entrance. If the appropriate software has already been stored in the mobile telephone, the mobile telephone now identifies a transmitter such as this. The associated software is now, possibly automatically, initiated on the mobile telephone 7, and, if required, an additional check is carried out, for example, by the person entering a PIN code, for security reasons. Once this person has entered the PIN code, the PIN code together with the unique address of the specific Bluetooth/WLAN appliance 9 of the specific main entrance are automatically transmitted from the mobile telephone to the access control system. This is done via the GSM network, either in the form of an SMS or by means of a telephone data transmission, or even possibly by means of an e-mail or some other transmission based on a specific protocol. The access control server 4 in the access control system now checks whether this mobile telephone 7 or this mobile telephone number, because the identification is not linked to the appliance but to the number assigned to the mobile telephone number, is authorized to use this gateway at this time (on the basis of the unique address, or on the basis of a corresponding information item produced from this address), and whether the PIN code that has been entered is correct. If all the conditions are satisfied, the access control server 4 will actuate the associated controller 3 in such a manner that the locking mechanism 8 of the gateway 1 is influenced in such a manner that that person can enter.

A further advantage of the method is that the person can change his personal mobile telephone 7 at any time without losing the authorizations. The only important factor is that the SIM card and thus the telephone number of the mobile telephone being used remain the same. This is advantageous especially when using two or more mobile telephones 7 with one mobile telephone number. This flexibility is possible because no data relating to the access control system is stored in the mobile telephone 7, but at most the software that has been mentioned, which is automatically downloaded once again when necessary for each contact, and the transmitter 9 does not need to know the unique Bluetooth/WLAN address of the mobile telephone 7. In pure access control systems which are based on Bluetooth, this problem can be solved only with a large amount of complexity.

In addition to reliable identification in situ, the method also allows identification at any desired distance from the gateway 1, provided that the mobile telephone is located sufficiently close to a Bluetooth/WLAN transmitter, that is to say provided that the mobile telephone is located in a specific and defined area. Wide-area initiation can thus be implemented without any limits, while nevertheless being linked to one location. This variant is possible in particular because the transmitter 9 need not be connected to the controller 3 and furthermore because, if required, a plurality of transmitters 9 are possible for each access point. Works vehicle entrances for suppliers are one such example, or a remote opening of a gateway 1 by means of a system controller who has no access to his control station 10 but is on site within range of the transmitter 1 which is associated, inter alia, with this gateway 1. In this context, solutions are possible, for example, in which a person in a specific working area, for example in a room with video cameras which are monitoring specific accesses, and in which room a Bluetooth/WLAN transmitter is located, have the power to use a mobile telephone to open a gateway point which has been monitored by one of the video cameras.

### LIST OF REFERENCE SYMBOLS

1 Gateway
2 Reader
3 Controller
4 Access control server
5 GSM server
6 Antenna (schematic)
7 Mobile telephone
8 Physical locking mechanism (lock)
9 Bluetooth transmitter
10 Control station

1. An access control system having
a standard access control system, via which a large number of access points can each be controlled via individual physical locking mechanisms, with at least one reader as well as a controllers, which is connected to it, for controlling the locking mechanisms being provided at each access points, and with at least one access control server being provided, which carries out central management of the access data and is connected to the respective controllers;
at least one mobile telephony server connected to the access control server, which is at least indirectly able to send data via a mobile telephone network to mobile telephone subscribers, and to receive data from them, in which case this mobile telephony server may also be an integral component of the access control server;
characterized in that
a short-range transmitter is provided at one specified location and transmits access-point-specific identification information in such a manner that this is received by a mobile telephone which is located in the reception area of the transmitter, and is used at least indirectly by this to control the access control at a specific associated access points.

2. The access control system as claimed in claim 1, characterized in that the specified location is a location in the area of the associated access point, such that the identification information from the transmitter can be received by the mobile telephone only in the immediate vicinity of the access points.

3. The access control system as claimed in claim 1, characterized in that the specified location is a location in front of the associated access points, or is a specific working area.

4. The access control system as claimed in claim 1, characterized in that the transmitter is a Bluetooth appliance, particularly preferably with a range of less than 10 meters, and in that the authorized mobile telephone has a Bluetooth interface.

5. The access control system as claimed in claim 1, characterized in that the transmitter is a WLAN station, and in that the authorized mobile telephone has a WLAN interface.

6. The access control system as claimed in claim 1, characterized in that the identification information is a hardware-specific, unique address of the transmitter, particularly preferably an appliance-specific 48-bit address of a Bluetooth appliance, or an address which is specific to a corresponding appliance for a WLAN appliance or a WLAN network.

7. The access control system as claimed in claim 1, characterized in that the transmitter is in the form of an independent unit, which preferably has no direct connection to the standard access control system and/or to the mobile telephony server.

8. The access control system as claimed in claim 1, characterized in that the standard access control system also allows access control using means without mobile telephony, in particular based on RFID technology.

9. A method for access control, particularly preferably using an access control system as claimed in claim 1, with
a standard access control system being provided, via which a large number of access points can each be controlled via individual physical locking mechanisms, with at least one reader as well as a controller, which is connected to it, preferably being provided in order to control the locking mechanism for each access points, and with at least one access control server being provided, which carries out central management of the access data and is connected to the respective controllers;
and with at least one mobile telephony server being provided, connected to the access control server, which is at least indirectly able to send data via a mobile telephone network to mobile telephone subscribers, and to receive data from them, in which case this mobile telephony servers may also be an integral component of the access control server;
characterized in that
a short-range transmitter is provided with a specified location, preferably at at least one access point, in that
a mobile telephone is authorized for access at specific access points in a specific time period via the access control server, and/or via the mobile telephony server via the mobile telephone network,
in that the transmitter transmits access-point-specific identification information continuously or at times, in such a manner that it can be received by only a mobile telephone which is located in the reception area of the transmitter,
in that a mobile telephone which is located in the reception area of the transmitter detects the identification of this transmitter via this identification information,
and in that the access point associated with the transmitter is then opened, with direct or indirect use of this identification information, via the mobile telephone, the mobile telephone network, the mobile telephony server, the access control server and the controllers.

10. The method as claimed in claim 9, characterized in that the transmitter is arranged in the vicinity of the access point in such a manner that the mobile telephone can receive its identification information only in the immediate vicinity of the access point.

11. The method as claimed in claim 9, characterized in that, after detection of the identification information, the mobile telephone additionally demands the input of an authentication in particular such as a PIN code, password or biometric information, and this user-specific information is transmitted together with the identification of the access point to be processed via the mobile telephone network to the mobile telephony server and to the access control server, which then activates the associated controller.

12. The method as claimed in claim 9, characterized in that the mobile telephone transmits the identification information and if appropriate the PIN code via the GSM network in the form of a telephonic data transmission or in the form of an SMS to the access control server.

13. The method as claimed in claim 7, characterized in that the transmitter is a
Bluetooth appliance or a WLAN appliance, which transmits its unique address as identification information, and this address is used to identify the associated access point, and in that the mobile telephone has a Bluetooth interface or a WLAN interface, in which case the mobile telephone automatically starts an appropriate dialogue with the mobile telephone user on reception of specific addresses of this type which are transmitted in the course of the authorization process and correspond to the authorized access points, possibly requests authentication of the user, and in any case then transmits a request to open the specific access point via the mobile telephone network to the mobile telephony server and to the access control server.

14. The method as claimed in claim 9, characterized in that the transmitter is a Bluetooth appliance or a WLAN appliance, which is arranged in the area of the gateway in such a way that the identification information can be received by a mobile telephone only within a distance of less than 1 m, particularly preferably less than 0.5 m outside and in front of the gateway.

15. The method as claimed in claim 9, characterized in that the transmitter is a Bluetooth appliance or a WLAN appliance, which is arranged in a specific area in front of the associated access point, or in a working area associated with the access point.

16. A time recording system having
a standard time recording system which comprises at least one time recording server which carries out central management of the time data;
at least one mobile telephony server in conjunction with the time recording server, which is at least indirectly able to transmit data via a mobile telephone network to mobile telephone subscribers, or to receive data from them, in which case this mobile telephony server may also be an integral component of the time recording server;
characterized in that
a short-range transmitter is provided for at least one authorized areas and transmits area-specific identification information in such a way that it is received only by a mobile telephone which is located in the immediate vicinity of the authorized area, and is used by this mobile telephone at least indirectly for the manipulation of the time data.

17. A method for time recording, particularly preferably using a time recording system as claimed in claim 12, with
a standard time recording system which comprises at least one time recording server carrying out central management of the time data,
and with at least one mobile telephony server in conjunction with the time recording server, which is at least indirectly able to transmit data via a mobile telephone network to mobile telephone subscribers, or to receive data from them, in which case this mobile telephony servers may also be an integral component of the time recording server;
in that a short-range transmitter is provided for at least one authorized area,
characterized in that
a mobile telephone is authorized to input time data in specific authorized areas, in at least one specific time period, via the time recording server and via the mobile telephony server via the mobile telephone network,
in that the transmitter transmits area-specific identification information continuously or at times, in such a manner that it can received only by a mobile telephone which is located in the immediate vicinity of the authorized area,
in that a mobile telephone which is located in the immediate vicinity of the area detects the identification of this area via this identification information,
and in that time data is then transmitted to the time recording server, and/or is checked by the latter, via the mobile telephone, the mobile telephone network and the mobile telephony server.

18. A data processing program, which can run on a mobile telephone, for carrying out a method as claimed in claim 9, which is designed to transmit identification information, received via a Bluetooth or WLAN interface, from a transmitter, possibly together with additional information requested in a request, such as a PIN code, a password or biometric information, automatically via the GSM 5 network to an access control server.

19. A mobile telephone having a data processing program as claimed in claim 18.
